(19) United States
(12) Patent Application Publication
(10) Pub. No.: US 2001/0042802 A1
(43) Pub. Date: Nov. 22, 2001

(54) Formulae, methods and apparatus for the treatment of, processing of, pasteurisation, dissociating water in, and the comminution of: materials; sewage; and bio-solids

(76) Inventor: Mark William Youds, London (GB)

Correspondence Address: Dr. MARK YOUDS, 158 MONKLEIGH ROAD, MORDEN, SM4 4ES, GB

(21) Appl. No.: 09/826,774

(22) Filed: Apr. 6, 2001

(30) Foreign Application Priority Data
May 18, 2000 (GB) 0012053.5

(51) Int. Cl. B02C 19/06

(52) U.S. Cl. 241/5

(57) ABSTRACT

A process comprising: methods, apparatus formulae; and factors, for: creating factors of vortexian energy sources; treating, processing; pasteurizing, dissociating; and comminuting: materials, bio-solids; and sewage; whereby space energy sources are released; drying and elimination of pathogens takes place; further comprising a feed assembly with conical section and inlet tube having a discharge area and inlet area for the passage of air and material and a rotor for creating reverse vortices in a cyclonic air-stream within the conical section and inlet tube; comprising Mark Youds', ‘Factors of Vortexian energy sources’, within the apparatus, and his formulae for utilizing those factors, so as to configure the invention, and any similar apparatus, in such a manner that it will also create a harmonic complex pitch wave, to assist the treatment and processing of the material, and a centripetal ‘boundary cylinder’ with ‘boundary envelope’ inside the conical section.

### CROSS REFERENCE TO RELATED APPARATUS

Apparatus for granulating materials where no grinding elements are involved, are well known. The principle of such apparatus is to granulate the material due to collision and self-abrasion between the individual lumps or aggregates of the material within at least one vortex formed in a cyclonic air stream. U.S. Pat. No 5,402,947 describes such an apparatus in which an air stream at high pressure, together with the material to be granulated, is fed into a cyclone chamber. It is claimed in Patent WO9835756 that a single vortex is formed within the chamber, which entraps the material and subjects it to violent turbulence thereby causing it to break up through collision and self-abrasion. However, the movement of the material within the vortex caused severe abrasion and wear of the walls of the cyclone chamber and impeller. (After only one hour, at varying, speeds, 6000 kg (6 tons) of glass rendered the rotor inoperable and caused considerable damage to the lining of the housing containing the rotor. The damage sent the rotor out of balance and destroyed the bearings.)

It has been found that the pressure of the air stream within the conduit is an important factor in the processing process, sub-atmospheric pressure being relatively important and the actual working pressure relatively critical to efficient operation. Therefore, the air must be drawn through the conduit by a suction fan or blower through which the air stream and entrained particulate material must eventually pass. The fain would, therefore, be subject to severe wear from the passage there-through of the particles entrained within the air stream which are traveling at very high velocity. Such pneumatic or vacuum comminution is described in U.S. Pat. No. 3,147,911. This particular comminution was utilized for crop grinding. It comprised a vertically rotating fan in a housing having a horizontal inlet along the fan axis. However, the fan was subject to severe wear with unacceptable metal losses from the vanes of the impeller fan. Furthermore, the apparatus was not suitable for processing harder material such as stone, coal cement, etc.

Other devices and methods, for or relating to, treatment of materials such as sewage are known. These include those methods and devices disclosed in U.S. Pat. Nos. 3,147,911, 3,255,793; 4,390,131 and 4,892,261, and PCT/GB98/00422, all of which are specifically incorporated herein by reference in their entirety. The specification should be considered exemplary only with the true scope and spirit of the invention indicated in the claims attached This invention seeks to overcome the above-mentioned disadvantages by providing apparatus capable of processing materials, such as biosolids, efficiently whilst minimizing, wear of the impeller fan. When the apparatus, configurated according to this patent processed 25 4 millimeter (hereafter abbreviated as ‘mm’ [1 inch]) lumps of rock at a rate of 18,000 kilograms (18 tons) per hour there was no significant wear on the steel rotor, that had no abrasion resistant coating.

STATEMENT REGARDING FEDERALLY SPONSORED RESEARCH OR DEVELOPMENT: Not applicable

REFERENCE TO A MICROFICHE APPENDIX: Not applicable.

REFERENCE TO A MICROFICHE APPENDIX: Not applicable

### BACKGROUND OF THE INVENTION

New legislation in many countries is making it increasingly difficult to dispose of sewage into the sea or spread it on land, due,. amongst other reasons, to its high content of pathogens. Current techniques for drying sewage, mixed with, for example, lime to combat pathogens, are very expensive. By a special processing technique of the patent invention it will remove many of the pathogens and/or the sewage at the same time. Market research has shown that the current cost of treatment can be dramatically reduced when using this invention. It will enable companies to substantially reduce transport costs. The end product can also be used in many applications such as fertilizer or to generate electricity.

Conventional comminution energy costs are 5 times higher, by comparison, than this invention. As such, the apparatus could be utilized in coal, steel, quarrying cement, mining, Yttrium, and brick industries. The invention also processes, amongst other materials, glass into rounded particles with few jagged edges, and will alter the structure of clay substances to produce a far superior brick than the end user would originally have had.

### BRIEF SUMMARY OF THE INVENTION

This invention relates to apparatus and methods for the processing, pasteurization, and treatment of materials, sewage, and bio-solids, and to an impeller rotor suction fan for processing such materials. In particular, but not exclusively, this invention relates to formulae-designed apparatus for treating and processing materials, sewage and bio-solids and to methods for treating sewage biosolids It also relates to apparatus, which will dissociate water and air, and also comminute. The invention comprises Mark Youds', ‘Factors of Vortexian energy sources’ within the apparatus, and his formulae for utilizing those factors.

### BRIEF DESCRIPTION OF THE SEVERAL VIEWS OF THE DRAWINGS

FIG. 1 Side elevation of part of the apparatus according to the present invention showing the fan in part section line 1 to 1 being the inlet tube; and area 2 to 2 being the conical section,

FIG. 2 An illustrated guide for use with the formulae and equations;

FIG. 3 Transverse cross-section of the apparatus of FIG. 1 taken along the line 3 to 3;

FIG. 4 Transverse cross-section of the Impeller rotor suction fan;

FIG. 5 Cross-section of the vane of FIG. 4 taken along the line 5 to 5;

FIG. 6 Cross-section of the vane of FIG. 4 taken along line 6 to 6;

FIG. 7 Cross-section of the vane of FIG. 4 taken along the line 7 to 7;

FIG. 8 Detailed plan view of a vane of the fan according to the present invention;

FIG. 9 Profile of the vane of FIG. 8;

FIG. 10a Side elevation of the interrupter according to the present invention;

b Plan view of the interrupter according to the present invention;

FIG. 11 Perspective view showing an embodiment of the apparatus according to the present invention; and

FIG. 12 Sewage and material processing and treatment apparatus according to a preferred embodiment of the present invention.

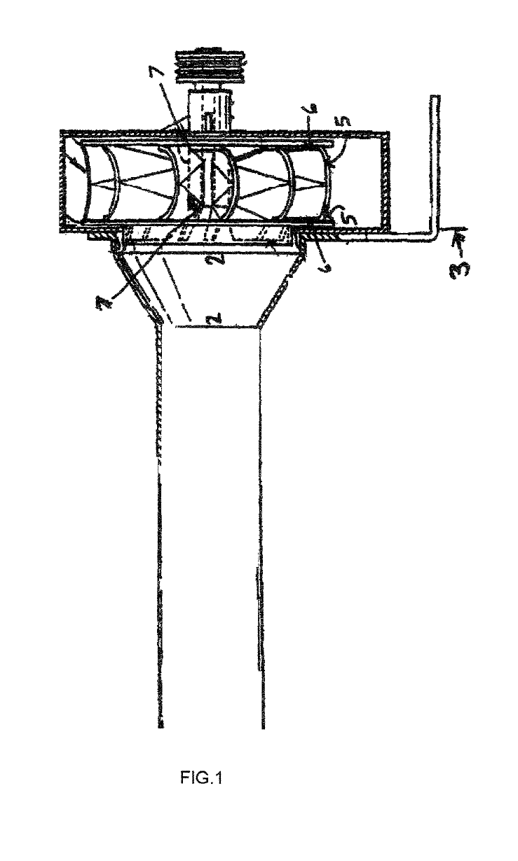

### DETAILED DESCRIPTION OF THE INVENTION

It has been found that a cyclone created in a stream of air passing through a conduit, preferably of circular cross-section, with centripetal forces (which are equal to the electric and magnetic forces in one of the main reverse vortices) created by the motion of the air stream pull any particulate material entrained in the air stream away from the walls of the inlet tube (mid-way) and towards its central region. If a wide range of sub-sonic, sonic and ultra-sonic frequencies and vibrations are created within the conduit, a hexagonal (assumed shape) lattice of superconductive vorticles, which can create ‘Cooper Pairs’ of electrons within ‘Soliton’ waves when the correct frequencies are input (explained later in the formulae with over 20 equations), and non-superconductive powerful vortices is created in the air stream. The motion of the vortices is also converted into sound energy.

Energies are released by conversion of potential energy into, amongst other energies. kinetic energy due to the stresses created within the cyclone, which cause minute explosions and/or implosions (depending on the medium). The energy within the vortices of the cyclone is capable of breaking up the material further into smaller particles.

It has also been found that the vortices, some containing quasi single pole quantum singularities, created in the cyclonic air stream carry further frequencies generated by the specially designed apparatus.

This sets up pulses without and within a standing wave confirmation within the system, and this causes pockets of air within the standing wave to achieve velocities beyond the sonic range. This can be tuned for a particular type of material, which enhances the ability of the vortices created to break up hard and soft materials such as stone and to dry materials

The more energy that went into forming rock the greater is the comminution potential. However, the opposite is the case for dissociation. The greater the energy input to the sewage, the less the dissociation potential. (The ideal sewage, known to date, would be centrifuged and transported without the aid of a screw-feed device—although those skilled in the art can determine how much energy went into the material.) e.g. It is unlikely that many types of river-bed silt would dissociate adequately for commercial purposes and neither would heavily plasticised sewage.

Mark Youds' ‘Factors of Vortexian energy sources’.

Cavitation: In ‘Negative Pressures and Cavitation in Liquid Helium’, by Humphrey Maris and Sebastian Balibar, it states that ‘When subject to intense sound waves, liquids can be stretched until they break and gas bubbles appear’. Although various types of cavitation occur in the invention and assist the dissociation and comminution processes it nevertheless does not explain how it may occur or how the dissociation and/or comminution/particle displacement takes place. In the explanation below there is a large enough range in pressure and temperature levels to satisfy the Bernoulli equations. However, the processes, which suddenly change the pressure and temperature, occur simultaneously, at the precise moment that conflicting and complementary frequencies meet after traveling from opposite parts of the invention

During particle cavitation—according to the sound-wave chemistry of Philip Boudjouk, Chemist, North Dakota State University—ionization occurs, and certain electrons give up thousands of electron volts to produce heat. At this point, the apexes of certain vortices are going faster, reducing frictional resistance, increasing the density—proven in 1952 by Dr Franz Popel at the Stuttgart Technical University—and reducing the temperature, therefore, the magnetic field strength will increase. (Note. at 4 degrees Celsius [centigrade. [{9.2 F}] in the phased electro-diamagnetic field, diamagnetic forces in water vortices are released, causing an increase in the speed of sound, from water prior to implosion.)

An acoustic pressure amplifying oscillation and intensifying vibrational ultrasonic wave traveling through the ions produce a sound pressure level of between 500 atm and 147,000 pounds (66,667 kilograms) per square inch (25.4 mm), increasing the temperature on a micro level by many thousands of degrees Fahrenheit/Celsius/Kelvin, but not more than 10 degrees overall. (This occurs in a ‘boundary envelope’, located in the ‘boundary cylinder’—to be explained later) This would have the effect of dramatically reducing the amount of pathogens, but not all of them, and speeding up chemical reactions. At this moment (of ‘critical intensity’) of superposition between the ‘sub-critical intensity’ waves of phased and out of phase particles, either explosions and/or implosions [depending on the medium] take place together with an increase in heat. In this locality is situated a resonating two-dimensional (due to an ellipsoidal time harmonic function, relative to its dimension in space) convex complex pitch discharging ‘corona’—hereafter referred to as the ‘corona’ This is not sonoluminescence, although there are similarities (with Chemiluminescence also) —in part due to the ‘Youds Factor’ (outlined later), which, physicists skilled in that field should find, will assist them in understanding why sonoluminescence can occur. The formulae (outlined later), which utilizes different frequencies from sonoluminescence, results in the process being more permanent and efficient than a laboratory experiment.

The ‘corona’, whose nearby electric field is a time harmonic solution of Laplace's equations in spherical co-ordinates that also interacts with a magnetic field, hermetically seals the high pressure sound level inside a ‘boundary envelope’—explained later in this application. The ‘corona’ is situated at the apex of a leaning reverse vortex, who's convex base emanates from the interrupter. A vacuum is created between the concave part of the interrupter and the convex base of the vortex. The interrupter is another high frequency, and high amplitude, resonating complex pitch generator (whose pitch is relative to the vibrational frequency). Whilst rotating at speeds dictated by the formulae outlined later, the leaning reverse vortex creates a ‘cylindrical boundary shape’ between 66.34458406 mm and 107.3478003 mm long (a Phi ratio of 1.61803411), with a resonating caliber base (with a Phi ratio of 1.61803411) of between 21.118137 mm and 34.1698661 mm.

The base caliber depends on the length ‘C’ of the ‘cylinder’, as the diameter of its base is exactly the length of the ‘cylinder’ divided by Pi. (The equation to find out length ‘C’ is given later The axial length of the ‘cylinder’ will vary according to the speed of sound and the required frequencies to be input into the apparatus—explained later in the formulae with over 20 equations.) The resonating caliber also produces a complex feedback loop in the ‘boundary layer’ of the ‘cylindrical shape’, which, in part only, assists in breaking down the anti-nucleation energy barrier. About 53% of the way up is the apex of a ‘boundary envelope’, centrally located inside the ‘boundary cylinder’.

Therefore, a great deal of potential energy is obtained from the high volume resonating complex pitch of the frequencies (when the cavitation heterogeneous nucleation bubbles expands) at the precise moment the kinetic energy is being concentrated (when the cavitation bubble explodes). Please note that in the ‘corona’ this phenomenon is not as a result of quantum tunneling. However, outside of the ‘corona’ it is as a result of quantum tunneling.

It is well established that any destructive resonance must usually be in acoustic ‘harmony’ with the circumference of the object. The complex pitch and tones must be concordant and complete, (and therefore will correspond to the Phi standing columnar wave ratio and the Pi ratio of the base of the ‘boundary cylinder’ circumference [which we demonstrated earlier], with an infinite sympathetic vibration at the eye of the harmonic (at the apex of this self-polarized logarithmic Helix) within the oscillating particles/waveforms. (This is indicative of the ‘corona's’ photons existing at both their alpha state and omega state, simultaneously, when the electromagnetic wave fields ‘particles’ interact with the torsion field teleportation transmission.)

High speed video photography of the inside of the conical section and rotor, has successfully recorded the existence of the reverse vortices, whose growth and stability depends upon the interrupter's peaks gradient velocity. (So powerful is the reverse vortex action that some of the water in sludge is separated from the solid, in the form of pure water, and return back down the wall of the inlet tube whilst sludge is being fed in—this occurs only when the speed of the impeller is not high enough for near complete dissociation and when the dry solid content is only about 5%.)

Powder and pure water have been seen coming back down the all of the inlet tube (The point where the conical section and the inlet tube meet should preferably be smooth, with no uneven joints [Rocks introduced into the conical section traveled in the opposite direction to the impeller at the same time as other rocks were traveling in the same direction as the impeller.]) This invention also dissociates water, creates ozone, after dissociating, air, to assist in reducing the smell of the sewage, creates N2, and communicates rocks and materials containing oxygen. It will only comminute plastic/rubber if soaked in liquid nitrogen.

Dissociation

Dissociation of water, due to an electron flow vibration—to form hydroxide ions; negative hydroxyl ions, hydrogen radicals, hydrogen peroxide: positive hydronium ions; oxidized hydrogen protons; various oxygen compounds; the elimination of bacteria; and the initiation of the formation of micro floc, can occur, amongst other processes, through electrolytic processes.

The harmonic and enharmonic frequencies and ion-acoustic oscillating vibrations, enhanced by an instantaneous sweeper wave-form, occurring within the invention, provides the same, if not better, impetus as the electrical pulsating signal that occurs during those processes. (The pitch frequency being a harmonic of the spectrums combined cube atomic weights of all the elements present, inversely oscillating.)

The ExB vortex (with the potential to cause the Hz value to drift occasionally by about only 0.58987 Hz when the ambient air temperature is just below 2.5 centigrade [27 5 Fahrenheit]) in the magnetic field excites the molecules further, thereby improving dissociation, and ionization The frequencies focus on the weak hydrogen bonds rather than the oxygen molecule. In the magnetic field, positively charged hydrogen is compressed during cavitation, which results in it also heating up. The magnetic field also compresses the hydrogen, which will emit ionizing radiation, depending upon the acoustic wave-forms present.

The intense disruption, caused by the action within the vortices and reverse vortices (at the apex of particular vortices electrons are created) in the cyclonic airstream, together with the shearing action of the impeller's blades (vanes—the number of which depends upon the application's required intensity of frequency), will alter the chemical structure of the water, for example, by turning some of the water into hydrogen peroxide. The word ‘dissociation’ therefore does not adequately describe the chemical activity which changes the hydrogen and negatively charged oxygen molecules into other molecular structures by breaking their covalent sigma bond.

In electrolysis, an electrical pulse signal must be generated in the form of a square wave and must also be generated in inverse relation to the conductivity of the water. When correctly configured, the invention becomes a high-order harmonic complex wave form generating synthesizer, wherein the conduction angle has been fixed to maximize the output of the desired harmonic. (See U.S. Pat. No. 5,990,712)

By setting the dimensions and configuration in the manner expressed in this patent we can determine which frequencies are present in the invention. Every third harmonic smoothes the overall shape of the wave-form—which is in inverse relation to the conductivity, of the water, and every odd harmonic has the effect of squaring the wave-form. The pulses also release iron cations (some of whom are depolarized) from the iron in the fabrication of the invention. Iron cations form compounds such as [Fe(H.sub.2 0).sub 8 (OH).sub.2] which polymerize and initiate the formation of floc in the form of micro-floc, and metal hydroxides are also formed as precipitates. The cations could also destroy cyanide. (See U.S. Pat. No. 3,933,606.)

Preferably it would be more advantageous, with regards to increasing the percentage of pathogens removed from sewage, to ensure that the sewage had a pH value of 8 to 10 (a HCl or NaOH aqueous acid base may be used, together with traces of a proteolytic enzyme) which brings the hydroxide ion concentration to a level that provides the most economic contaminant removal. The increase in pH will reduce hydronium concentration, thereby increasing electrocatalytic ion or couple cations, Combined with the cavitation process referred to earlier, nearly all of the pathogens would now have been removed—dramatically reducing the settlement time—and in may cases all the pathogens would now be removed, especially if a conductive salt solution is added to the process, and afterwards a pathogen eating bacteria. The newly dissociated oxygen will activate the sewage when it mixes with the bacteria and the organics. The organics then begin to break down.

A non-dissipating traveling electrical impulse is also located around the ‘boundary cylinder’ due to the fact that we have a high speed ‘welded’ rotor, creating a constantly changing magnetic field containing some adiabatic electrons that move parallel to the magnetic field (whose topography changes near the ‘corona’) and at right angles to the electrical field—meaning the invention is generating electricity To further aid the magnetic field the invention would preferably, but not necessarily, be placed in alignment with the Earth's magnetic north—i.e. with the back of the housing facing South and inlet pointing North. Additionally, it is preferable, but not essential, if during times of increasing gravitational pull from the moon, the apparatus faced away from the moon.

At this point it is worth referring to the Mills U.S. Pat. No. 6,024,935 (utilizing a new atomic theory) which refers to a nickel cathode (the interrupter is preferably—but not necessarily—made of a high content nickel alloy with traces of copper, zinc, and selenium), one of the preferred embodiments in that Patent being to use ‘an intermittent square-wave having an off-set voltage of approx.’ 1.4 volts’ . . . with an applied frequency.

Vacuum

Anyone familiar with homopolar generators (for further details read ‘Homopolar “Free-energy” Generator’, a paper presented on Jun. 21, 1986 at the Society for Science Exploration in San Francisco, by Robert Kincheloe, Professor of Electrical Engineering at Stanford University) will accept that the invention's high speed rotor (preferably premagnetized) will emit an intensified voltage. This voltage assists in the process, it is not the cause. It assists when its oscillation becomes synchronized with the input frequencies.

The leaning reverse vortex of the ‘boundary cylinder’ has a 13.0517291 to 21.11814287 degrees gradient between the two interrupter ‘rounded peaks’—see FIGS. 10a and 10b. This vortex carries ultrasonic frequencies from the axis, in a constantly changing magnetic field, and contains a concave based vortex standing columnar wave ‘boundary envelope’ This base is just below the ‘zone of vacuum polarization’ produced by a plasma's acoustic mode—located at the boundary layer of the two-dimensional ‘corona’, at a hyper-spacial intersection between non space-time and space-time. (This smaller ‘envelope’ has an apex angle equal to its angle of torsion vibration, from which a standing columnar wave is created.) Presumably this particular boundary layer has no additional fermionic quantum dimensions, although it could appear to have Lorentz violating qualities.

The plasma may be produced by quantum vacuum radiation, with any light radiating from the ‘corona’ instantly dissipated—unlike sonoluminescence. To suggest a ‘black hole’ is being generated would be a fanciful and ignorant remark, as it is more likely to generate ‘stars’ from the helium and hydrogen than a quantum chromodynamic holographic matrix)

This particular vacuum in the invention, although relatively small, is important with regards to the electrical induction phenomenon and its place in quantum electrodynamics. (See, ‘Macroscopic Vacuum Polarization’, by Moray B. King.) Modern physicists see a ‘vacuum zero-point energy’ in a similar way to those scientists mentioned later who referred to ether.

When the frequencies are acoustically oscillating the ions at the same time as the electrical charge from the rotor core axis and/or further pulses out of phase are introduced, an implosion takes place inside the vacuum.

With the right conditions, the ‘corona’ can also ‘contain’ slowed-down high-energy neutrons, with nuclei that are Gravitationally and inertially confined, together with positronium, antiprotonic atoms and anti-hydrogen. The anti-matter may be nothing more than an ‘echo’ signature from an alternative dimension caused by: the negative entropy effect from the ‘corona’; and/or the incumbent torsion field—but also in part due to the particle speed of the space vortex energy. As it is not in space-time the strength of the two-dimensional aspect of the vortex is constant. The ‘cylinder’ also acts as a wave-guide containment field for the electro-magnetic waves, and as a gatherer of electrons in the transverse direction—a process that amplifies the sound in the ‘boundary envelope’, and is part of the star making process. The greater the tension, the higher the frequency

Space Vortex Energy

We should also take note of Paramahamsa Tewari's (Chief Project Engineer, Kalga Atomic Power Project, Nuclear Power Corporation, Karwar, India) opening abstract from his paper ‘Phenomenon of electric charge generation by space rotation’ (from, ‘The free-energy device handbook A compilation of Patents and reports by David hatcher Childress, ISBN 0-932813-24-9, Adventures Unlimited Press, 1995, chapter 8, page 191)’‘The medium of space (absolute vacuum without matter) is defined as an incompressible, zero-mass, nonviscous, continuous and mobile entity which, in its rotation at the limiting speed of light as a submicro vortex, creates electrons. The property of electric charge of electron and its electrostatic field can be shown to be the effect of rotation of space around the electron's center The mass property of electron is seen to be rising due to the creation of a spherical void hole) at electron's center where space rotates at the limiting speed of light’.

Apart from the references in this patent that help to explain the accepted science inherent within this invention we must amalgamate the various processes for a definition of how those processes occurred as the result of the on-going dynamics, created as a result of the formulae, within the invention. The apparatus (or any similar apparatus) will only process material successfully (i.e. being commercially viable—this patent is therefore the only method to achieve this) within the fixed parameters, derived from the formulae invented for this patent. This aspect is novel and therefore absent from any similar device. The first parameters are the required values of the frequencies to be input into the apparatus, and secondly the speed of sound at a given point. From there, the formulae Keith over 20 equations (outlined later) is utilized to establish the rotor speed, the length of the inlet tube, and acoustically tune the invention. (Rocks can be ‘comminuted’, amongst the other processes outlined in this Patent, when oxygen inside the rock fissures is temporarily dissociated—e.g. into two atomic fragments, one of these fragments having a low metastable Rydberg state and the other a high Rydberg state—which are ionized as a result of thermal collision. This is because an explosion will take place when the oxygen ‘re-associates’, causing a massive generation of energy on a micro level also.)

Although implosions may occur within, not without, certain material—except for dissociation only in the ‘boundary envelope’ vacuum—nevertheless it is again both fanciful, ignorant, and incorrect to say that rocks implode or ‘disintegrate’—empirically it has been seen that they do not. The explosions and/or implosions do not always cause the rock to completely break apart, rather it weakens the rock and makes it brittle. The rock will then impact upon the interrupter and break up—not a process of spontaneous disintegration—the larger pieces will bounce back within a reverse vortex that surrounds the ‘cylinder’ that excited the dipolar field.

This other vortex is centrifugal and so materials will first impact against each other, thereby creating smaller pieces. These smaller pieces then move towards the inner wall of the conical section, impact against each other, and finally grind against the wall, before moving between the vanes. At all times, the material is traveling within the flow of vortices, not traveling back and forth across a single vortex. (It is impossible to do both at the same time.) For the processing of material to be realised, the resonant acoustics of the medium must be ascertained by those skilled in the art—i.e. its ultra-sonic frequency value and its sonic frequency value. Once the values are obtained, the formulae with its equations are utilized to establish the length of the inlet tube and the rotor speed. Any number of the formulae's utilized equations will process material.

The length of the inlet tube may also be altered, to create the required ‘frequency’, using known equations related to wave formation, together with the formulae with over 20 equations (i.e. incremental steps in rpm and inlet tube length are almost linear [with a slightly curved degree of tolerant accuracy—see equations 19 and 20] and relatively fixed). This is neither ‘Acoustophoresis’ nor ‘Electrophoresis’, nevertheless those skilled in the art of Acoustophoresis could also identify the necessary values (representative—as no external source actually creates the frequencies and in their terms the ‘sonic value’ would only be a three digit ‘division’ of the first acoustic). Indeed, NASA (See NASA tech brief. January 1990) patented an invention (U.S. Pat. Nos. 5,192,450 and 5,147,562) in which, ‘. . . the second acoustic wave can be tuned to a frequency different from that of the first (acoustic wave), and to a different amplitude thereby producing a high resolution “shearing” of the liquid into its separate species’.

All of the inherent processes are interactive and depend upon one another for successful treatment of the material. This novel combination of processes occurs without a chronology (This Nexus to be known as the ‘Youds Factor’.) Its ‘Fluence’ is therefore immeasurable. The ‘Youds Factor’ cannot be underestimated, when you consider the simultaneous knock-on effect of the infinite spiraling of processes, and its potential on the nucleonic molecular mean squared velocity No time elapses between either implosion and/or explosion (depending upon the mediums) cavitation, or the extreme ranges in temperature and pressure etc (except for the vacuum created implosion that occurs at the boundary layer, of the ‘boundary cylinder’ hyper-spatial intersection—between non space-time and space-time).

Although the primary process takes place around the ‘corona’, the ‘boundary cylinder’ and the ‘boundary envelope’, other processes occur, other than at these three areas—for example, the reverse vortex which extends as far into the inlet tube as the length of the ‘boundary cylinder’. There are also the vortices contained within the vanes which continue the process after the vanes have sheared the material, and also the secondary, vacuum located between the interrupter's peaks.

This novel invention has processed and treated centrifuged sewage containing 21.4% dry solids, at a rate of 4000 kg per hour. The expelled powdered product contained 70% to 95% (depending upon the ambient air temperature) dry solid, and removed at least 25% to 50% of the pathogens, due to the configuration of the invention that creates reverse vortices upstream of an impeller rotor suction fan that also shears the sewage.

Furthermore, the fact that material is moving through the invention means that the material itself also produces vorticles—see: Richards. G. J. A.R.C.S., Bsc., P I.C., PhD., “On the Motion of an Elliptic Cylinder Through a Viscous Fluid”, London. Philosophical Transactions of the Royal Society of London, Series A, Vol. 233, pp 279-310; and Harlow, Francis H. and Fromm, Jacob., “Computer Experiments in Fluid Dynamics”, Scientific American, February 1964.

Electrons are being continually created, fed; and emitted (before doing any work) to further enhance the process and conversion of energy.

In the right circumstances, the apparatus could also be utilized to generate: hydroxide ions; hydrogen radicals, hydrogen peroxide; oxidized hydrogen protons; various oxygen compounds (with high and low Rydberg states); CO2; D20; ozone; N2; protium; deuterium; tritium; and helium—temporarily liquefied in 5 24 parts per million before being converted into mechanical energy. The very high centrifugal acceleration that is present assists in the stability of the ‘boundary cylinder’, despite the introduction of material to be processed. It is critical to the performance of the apparatus, that the material is fed in at a fairly even and constant flow rate. (An excess of material, or a high inconsistent through-put, may cause instability within the reverse vortices.)

Atomic Energy

The combustion energy equivalent to dissociate water, achieved by the invention, exceeds the energy required to run the motor. When the invention was being tested, it was also noted that the nearer the prototype got to its optimum configuration, the less were the amps that were being pulled.

The proof that CAF effects are limited is based on empirical evidence, characteristic of plasma fusion, namely the formation of Abrikosov vortices and temporary gamma-radiation that occur when the invention is correctly configured. This could mean that oppositely spinning pairs of photons would be present—according to John Griggs' 1954 ‘Unified particle theory’ in which he claimed that photons are cylindrical, as well as explaining why no time reversal is taking place. However, the electromagnetic radiation frequency is relative to the spectrum of the elements being processed and their resonant frequencies—with the ultrasonic frequency to be input (explained later) into the apparatus being proportional, to the ‘NMR frequency’ being relative to atomic mass, and cubic mass.

Instantaneously occurring sweeper wave-forms, referred to earlier, are often associated with thunderstorms, as are Abrikosov vortices, ball-lightning, electrical discharging plasma, and neutron formation (Read Nick Hawkins, “Possible Natural Cold Fusion in the Atmosphere,” Fusion Technology, 19, 2212 [July 1991].) The invention can therefore create permanent ‘storm’ conditions, similar to one occurring in nature, coupled with polarized space vortex energy. As such, the law of conservation of energy is maintained. However, any enlightened physicist could see that no laws of physics have to be reinterpreted It is simply, that the process can't be easily ‘visualized’, or therefore understood, by many.

Coulombic Annihilation Fusion

If Randell L Mills' atomic theory (Mills, R., The Grand Unified Theory of Classical Quantum Mechanics [1995], Technomic Publishing Company, Lancaster, Pa.) is correct, then Coulombic Annihilation Fusion—[‘CAF’]) is obviously taking place inside the invention. The CAF process present is not on-going due to a lack of nuclei during the neutron flux that nevertheless occurs after the spherical shock wave obtains a neutron split over neutron loss. When ‘CAF’ occurs, the ‘corona’ plasma's electrical resistance decreases. In contrast to the other vacuum areas, the only vacuum in the invention related to the CAF process is the one referred to at the ‘zone of vacuum polarization’.

To further understand atomic processes, please read the section, ‘Nature of excited states’ by James A. Patterson, Ph.D. (CETI) in his U.S. Pat. No. 5,607,563, together with Randell L Mills' atomic theory compounded in U.S. Pat. No. 6,024,935. (Also see ‘A new energy source on the horizon’ by Shelby T. Brewer, and investigate the atomic energy theory that recognizes the energy in electron spin, referred to by John Ecklin in U.S. Pat. No 4,567.407.)

Physicists of note

This section, ‘Physicists of note’, is for general information regarding old theories related to atomic theory. (The quotes contained in this section should be seen in the light of current understanding.) In the 19th Century, John Keely claimed he was, ‘ . . . able to draw vibratory energy directly from space by the aid of special resonating expedients’ He stated that this energy, ‘is duplex, or has two opposed conditions, like positive and negative states of electricity’. (The name given to this ‘space’ has changed according to the individual scientist, e.g. ‘scalar waves’, ‘tachyon energy’, ‘ether’ or, ‘negative-time-energy’, according to Robert Adams in Nexus, 30/4/1993. Adams went on to quote Nikola Tesla who said that sound waves travel at the speed of light i the ether, however, it is really particles of sound, rather than the speed of compression waves, which travel at the speed of light within vortices. These accelerating charged particles would produce vorticles, therefore the electron spin in the vorticles would give off ‘Synchroton’ radiation when spiraling into the magnetic field—see Scientific American, February 1969, 56) Furthermore, in the ‘Snell Manuscript’ (C. W. Snell, Delta Spectrum Research) Keely went on to say, ‘ . . . what we call electricity is but one of the triune currents, harmonic, enharmonic, and diatonic’.

Over a hundred years after Keely died, Dale Pond stated, in an updated article in January 1997 entitled, ‘Why Music? or What does music have to do with physics?’, that. ‘All quantum physics is based on frequency or the vibrations inherent in any and all elementary particles’. Bloomfield Moore and Clara Jessup in their book, ‘Keely and his discoveries’ (Delta Spectrum Research) wrote about Keely's ‘Compound Disintegrator’, because although nothing like the current invention Keely's devices utilized frequencies to create electricity and magnetic fields, and to dissociate water and matter.

Indeed, the Keely motor created a standing wave with two polarization zones within a resonator with two opposing pressure zones. (See, ‘The Keely Motor—How it works ’ by Dale Pond, IANS 1992.) The water inside the motor was subjected to impulses, which caused the water to expand and therefore the pressure was increased. Readers of Keely's work will notice that he often referred to ‘low atomic ether’ produced during dissociation

According to Dan A Davidson, pressure is placed on the nucleus of an atom when sound pressure is placed on a mass that has had a standing wave generated within it. Furthermore, in ‘On the production of Aetheric stress waves utilizing sound vibration or, Sonic Stimulation of the Aether’, he states that ‘The wavelength of sound—Nuclear magnetic resonance (NMR) rattles the nucleus’, when the frequencies are on the order of the nuclear particles, ‘based on the proton spin which produces a small magnetic moment’, because ‘the speed of sound is much slower than EM so a relatively low frequency doesn't travel very far before it has gone through a complete cycle and that distance is on the order of the proton spins resonance frequency. Thus, it is easy to see that sound call also resonate with the atomic level in as far as frequency is concerned.’

For a variety of definitions, not definitive or exhaustive however, of ‘harmony’, ‘frequency’ etc, (including Keely's method for what modem physicists call Acoustophoresis), see, ‘Universal Laws Never Before Revealed: Keely's secrets—Understanding and using the science of sympathetic vibration’, Message Company. 1995 (Dale Pond). Pages 33 and 34 of ‘Energy Breakthroughs to Free Energy Devices’, by Dan Davidson, also show how Keely could find the resonant frequency of a material.

The preferred (apart from preferences previously outlined) embodiment of this self-configurating (with respect to its internal volume) apparatus is about to be clearly outlined in detail. However, the following formulae with over 20 equations was invented to: optimize the preferred embodiment, optimize similar designed apparatus that has hitherto not been commercially viable; and also to realize all of Mark Youds' factors of Vortexian energy sources.

### DESCRIPTION OF THE PREFERRED EMBODIMENT

The mechanical formulae

To determine the ideal configuration of the invention, formulae is used to determine the ideal length of the inlet tube. This is because all parts of the invention have relative dimensions to the other parts when the required standing wave is obtained (note. complex wave harmonics can be found using the Fourier transform and integral sine wave calculations) together with the following: fundamental frequencies; frequencies (either in whole, heterodynes; multiples, or divisions of—typically across the first and fifteenth harmonics and/or Enharmonic spectra, and up to the one hundred and fiftieth); dominants; diatonics; harmonics; sub-harmonics, or sympathetic resonating isochronous wave vibrations thereof 13 to 990 Hz; 349.525 vibrationary pulses, 3,145,728 sympathetic vibrationary pulses (so short-lived and of such high intensity, no equipment could measure it) 1 to 3 Hz; 7 24 to 10.17 Hz; 27,618 Hz to 45,696 Hz. Please note that the harmonics and resonating complex pitch are amplified in the conical area

The following formulae, to find the optimum operative combined length of the inlet tube and conical section length (L) and rotor speed (R) at a given speed of sound value, and to acoustically tune the apparatus to the desired vibrationary ultra-sonic and sonic frequency value of the chosen material, is relative to the rotor speed being equal to 0.75 that of the air speed entering the inlet tube. In any machine where this is different, the 0 75 figure in ‘U’ should be amended accordingly. Those skilled in the art can either build the apparatus accordingly—relative to: the diameter of the rotor; the diameter of the inlet area to the rotor, and the diameter of the inlet tube—or amend the equations accordingly, which are in millimeters for length and millimeters per second for speed. (For those skilled in the art of Acoustophoresis: S (preferably, when S=X Furthermnore, more preferably when it can also be divided exactly by 6 [at which point if this one-sixth value equals ‘R’ divided by the circumference, then the rotor frequency gives off a perfect harmonic to combine with the enharmonic and diatonic in ‘H’]) is the relative frequency value for H; U, is the relative frequency value for T; and K (preferably when K divided by 2 equals the one-sixth value of the above preferred embodiment of when S=X) is the relative frequency value for I.) The key to the abbreviations is as follows

A=constant value 9;

B=variable value B;

C=maximum ‘boundary cylinder’ length,

D=distance from the start of the sound weave to the back of the hub;

E=Speed of sound value in millimeters per second, which must take into account the various temperatures; air/gas pressures; air/gas densities; air/gas humidity; processes and any adiabatic process taking place (Those skilled in the art can determine this value However, as an example, the speed of sound values present within the apparatus are accurate to plus 1.027309066 or minus 3.0819272 meters per second, depending upon the medium, in relation to values derived from ‘ambient’ air temperature; pressure and density.);

F=ultra-sonic frequency value, in the range 27,618 to 45,696, to be input into the ‘corona and vacuum polarization zone’,

G=distance from the back of the hub to the wider edge of the conical section (which preferably when being built should be equal to 203 mm [about the diameter of the inlet tube]. The figure of 203 mm should be used as ‘G’ in any apparatus. However every shortfall or increase—in its actual length should be added or subtracted to the length of ‘L’ after all 20 equations have been utilized.);

H=combined length of the conical section length and the sound wave,

I=inlet tube length;

J=conical section length; (A figure of 517.7 mm should be used as ‘J’ in every apparatus. However every shortfall or increase in its actual length should be added or subtracted to the length of ‘L’ after all 20 equations have been utilized.),

K=the sonic frequency value, in the range 103 to 359, to be input; (occasionally there is a direct relationship to this chosen value, and to that of the material's number of nonparticipating nucleons, with the few nucleons that are itinerant not only also relating to the number of waves, but also creating magnetic rotation of the nuclei in the ‘corona’.);

L=distance from the start of the inlet tube to the outside of the rotor housing casing,

M=length from the start of the sound wave to the outside of the rotor housing casing,

N=exterior distance from the wider edge of the conical section to the rotor housing, (a figure of 53 mm should be used for ‘N’ for any apparatus However every shortfall or increase in its actual length should be added or subtracted to the length of ‘L’ after all 20 equations have been utilized.),

O=optimum configuration for combined dissociation and comminution;

P=constant value 8;

Q=minimum length of the ‘boundary cylinder’;

r=radius of the inlet tube,

R=rotor tip speed (when divided by the circumference of the rotor and multiplied by 60=the rotor's number of revolutions per minute),

S=variable value,

T=air speed;

U=K divided by 0 75;

V=one-third of I;

W=one-third of X,

X=3K

Y=constant value 5; and

Z=optimum conditions for harmonic frequency precision

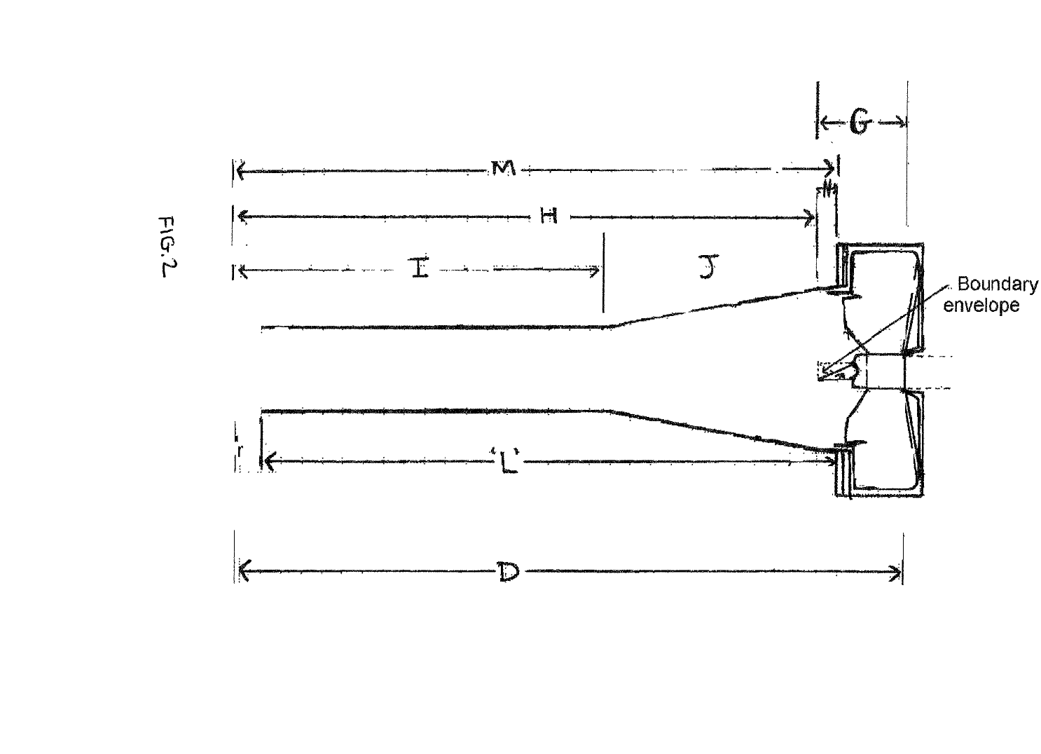

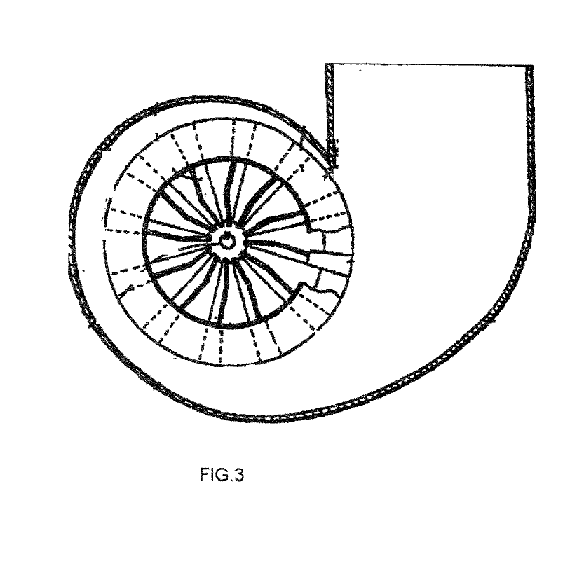

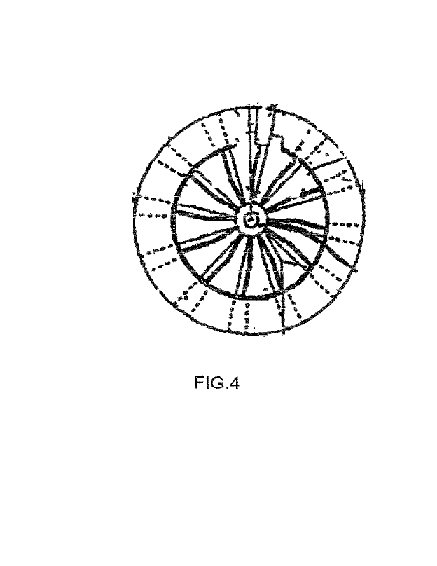

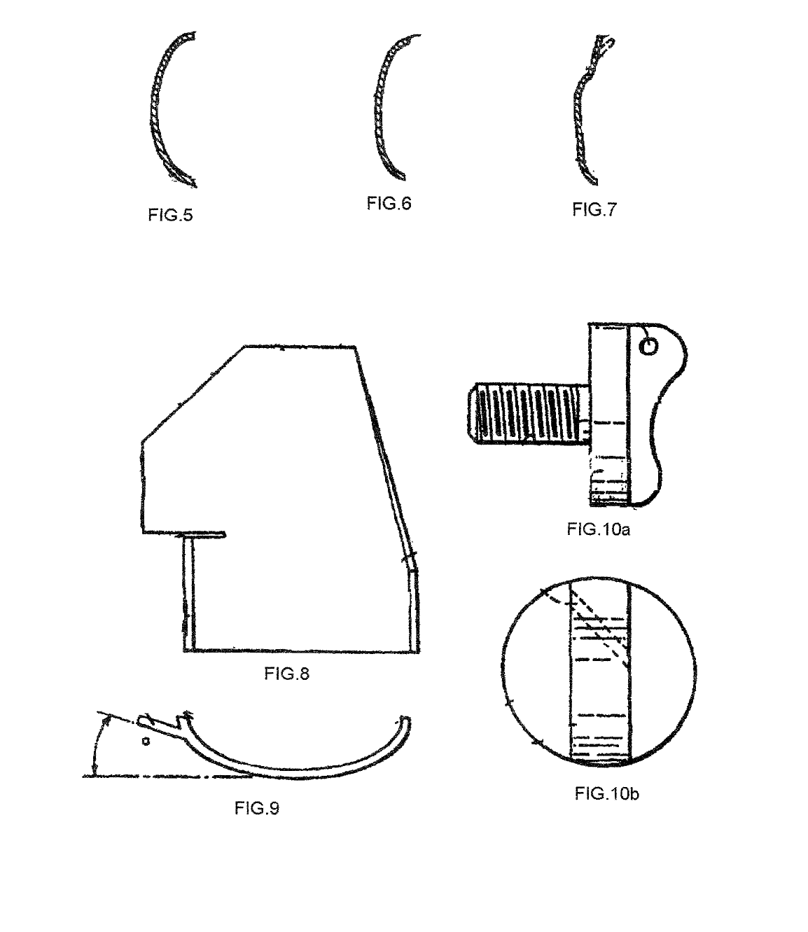

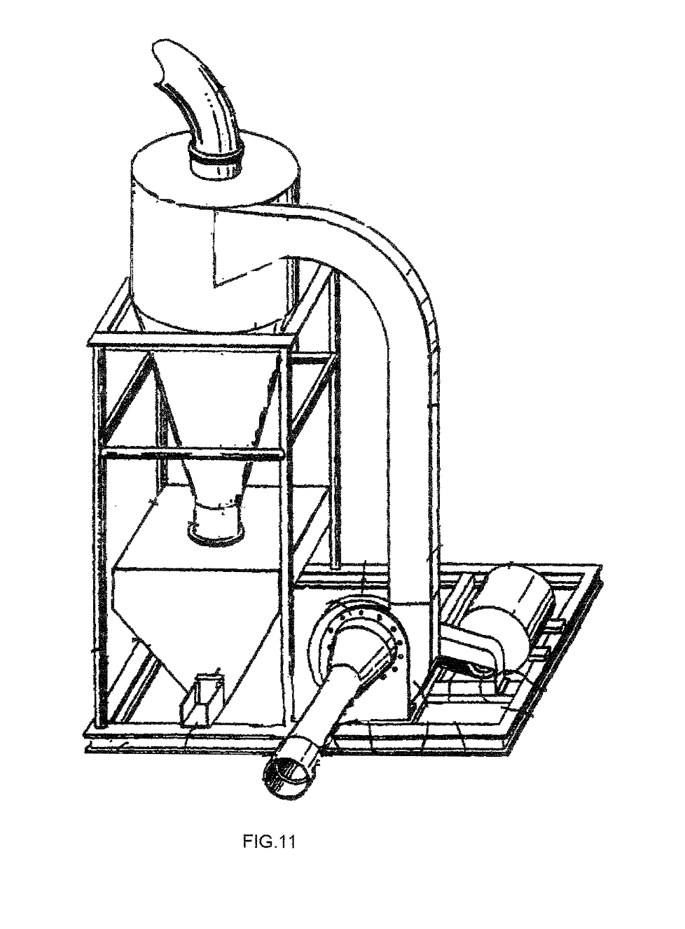

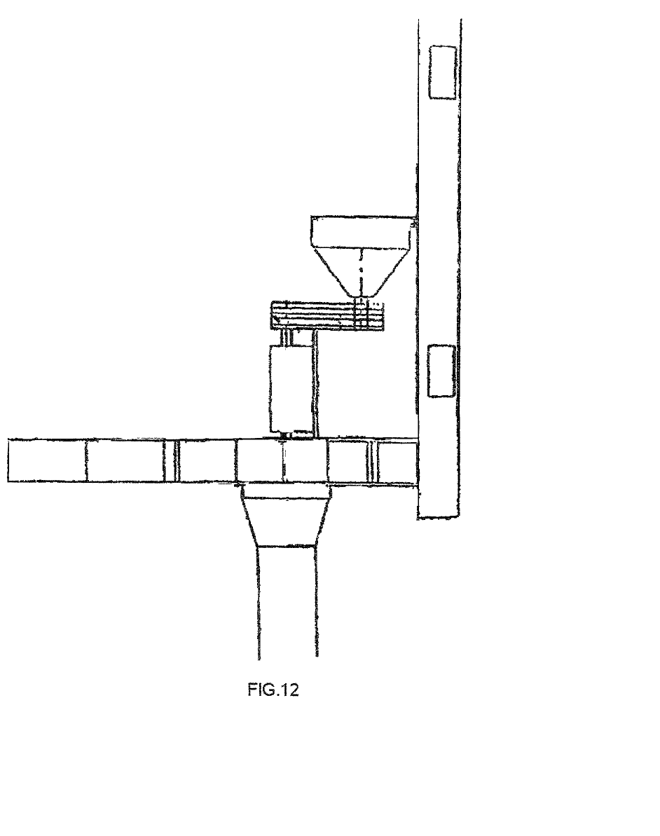

The main 20 equations (see FIG. 2 as an illustration):

1. F divided by A=B

2. E divided by b=C

3. 2(A multiplied by C)=D

4. D minus G=H

5. H minus J=I

6. I multiplied by K=R

7. H plus N=M

8. M minus 0.6 r=L

9. (H divided by 2) divided by P=Q

10. (E divided by 2H) multiplied by Y=S

11. T divided by I=U

12. R divided by X=V

13. I=T divided by U

14. W R=divided by I

15. Distance Q to C=The ‘corona’ and ‘vacuum polarization nexus zone’

16. When S=X, then Z

17. When C=Q then O

18. Space is folded, rather than time reversal, when C is less than Q

19. 3(R divided by S)+J+N−0.6 r−‘L’=degree of accuracy for ‘L’ in mm.

20. 3(R divided by S) multiplied by K, minus R, divided by the rotor's circumference, multiplied by 60=the degree of accuracy in the rotor's rpm.

To go further, beyond the boundaries calculated by equations 19 and 20, would result in the electro-magnetic field becoming linear once more (resulting in a decrease of the torque of the electrical and magnetic fields), and ‘L’ and ‘R’ no longer having a near linear relationship —for practical use. Furthermore, the quantum phenomenon could no longer be accurately controlled due to the loss of the identifiable pulsed (and angular anisotropy) interrelationship with our solar system's oscillation and muon magnetic moment, together with non-creation of resonating pions.

The ‘Youds Factor’ phenomenon can be achieved by apparatus which utilize the formulae with over 20 equations, for processing a material, comprising a conical resonance section and inlet tube; an impeller rotor suction fan for creating a cyclonic air stream within a cyclone chamber, the fan having an inlet and outlet for passage of the air stream therethrough; and a feed assembly for feeding material into the path of the cyclonic air stream for processing the material in the cyclone chamber, wherein the cyclonic air stream includes non-conflicting effects of vacuum-forming centripetal vortices, parts of which travel at supersonic speeds, series of harmonics and subsequent sub-harmonics inherent in the apparatus and induced; supersonic resonance which pulsates in an ultrasonic field; standing wave; thermal shock; pressure changes, cavitation, the stresses of which in combination convert the potential energy of material conveyed by the cyclonic air stream to kinetic energy.

The apparatus may include any one of, or any combination of, the following processes: pasteurization; processing, drying, de-watering; dissociation of water and or material, and comminution. This phenomenon can be achieved by an impeller rotor suction fan for a processor, according to an aspect of the present invention comprising a central hub and plurality of vanes extending radially from the hub for creating a cyclonic air stream, wherein the cyclonic air stream includes non conflicting effects of vacuum-forming centripetal vortices, parts of which travel at supersonic speeds; series of harmonics and subsequent subharmonics inherent in the processor and induced; supersonic resonance; standing wave; thermal shock; pressure chances; and cavitation. The formulae creates a standing wave within the material at the ‘corona’ To obtain a standing wave along ‘L’, then add ‘C’ to ‘L’ (A rough indicator of a standing wave being present is when a piece of string remains stationary in the air stream.) Note: ‘RPM’ means the rotor's number of revolutions per minute

An 8 vane impeller requires more energy than a 9 or 10 vane impeller, and is for a more specific application than the 9 or 10) This is because the 8 vane is less likely to: square the wave-form; smooth the wave-form, or reach the required sub-critical decibel intensity ranges —although it is better than a 9 vane at producing heterodynes. Furthermore, the peak frequencies generated by the 8 vane can be five-sixths of the frequency input for the 9 or 10 vane impeller (Which also creates more intense ‘black-body’ radiation in the ‘boundary envelope’.) Those skilled in the art of Acoustophoresis, together with those with knowledge of ‘noise and vibration’ can determine the required number of vanes suitable for a particular application by using the equations

The following equation can be used to establish the preferred number of vanes (‘F’ divided by 6) divided by (The RPM established from ‘R’, divided by 10)=the number of vanes to be used on the impeller. If the old Acoustophoresis data is used for ‘F’ then round up the figure, obtained from this equation, to the nearest whole number However, if new data for ‘F’ is used then round down the figure, obtained from this equation, to the nearest whole number Therefore, do not automatically go to the nearest whole number.) This formulae will show, that in hot climates more blades are required for comminution (above the mean value of 10), but less blades are required for dissociation. In a cold climate, more blades are required for dissociation (above the mean value of 10) but less for communication

The apparatus consists of a high-speed motor attached to the impeller rotor suction fan, a product discharge exit tube, a specially configured eight, nine, ten, eleven, or twelve vane impeller rotor suction fan that rotates horizontally or vertically, contained in a scrolled housing attached to which is a conical section whose outer wall slopes at an angle of preferably 10.6-13 degrees. However this angle would depend upon the actual length of the conical section, from the feed-in tube, and the diameter of the inlet tube

This inlet tube is parallel, in line with the fan axis, and can be mounted horizontally, or preferably vertical with the inlet tube, sucking material upwards due to the high velocity created by the impeller suction fan, thereby utilizing gravity to slow the flow of the material through the apparatus, thereby enhancing the processing and treatment of material, and increasing the internal static electricity—which increases with height.

The feed-in tube (inlet tube)will preferably have a diameter equal to one-third—plus or minus 12.7 mm [half an inch] the diameter of the rotor, and the conical section (which is attached to the fan housing casing) inlet area to the impeller suction must be two-thirds—plus or minus 25.4 mm [an inch] the diameter of the impeller suction fan. With a potential ‘solenoid’ field, a 25.4 mm (1 inch) metal ring, preferably (but not necessarily) made of brass, is located at the inlet to the impeller. Although this is part of the impeller, the vanes and the ring can make mechanical energy from the kinetic and thermal energy stored in liquids.

The apparatus further comprises a fan housing for supporting the impeller rotor suction fan, the fan having a plurality—preferably 9 or 10—of radially extending vanes Any ‘welding’ medium preferably, but not necessarily, contains traces of tungsten, however, fan must be made from material with sufficient tensile strength

The clearance between the outermost edge of the vanes and the fan casing may vary around the circumference of the fan such that, in operation, at least two-thirds of the vanes are fully pressurized—see FIG. 3. Further, the forward edge of each vane of the fan may be 1/24th of the diameter of the fan greater than the radius of the cyclone chamber. The fan casing may be lined with a layer of high abrasion-resistant material and the layer of high abrasion-resistant material may further comprise a groove extending circumferentially around thee fan casing. This scrolled fan housing casing should be as small as possible whilst yet large enough to allow free movement of the impeller, for example a clearance of only 10 mm between the tip of the vane and the avail of the housing next to one side of the outlet area, widening to 120 mm (between the tip of the vane and the wall of the housing at the opposite side of the outlet area, after a ⅔ rotor rotation) Note: All preferences are not necessarily a necessity

The impeller will preferably have a maximum width at its top (the concave part) equal to 90.148%—plus or minus 25.4 mm [a inch] of the diameter of the inlet tube Each vane may be coated with a high abrasion-resistant material, which preferably was achieved without heat treatment in which case the metal would preferably ,be magnetized afterwards. Preferably the material is processed within the cyclonic air stream before the air stream is disturbed by the fan. However, additional treatment is provided by the shearing action of the vanes as we as the frequencies and vortices apparent between each vane. Preferably, the vanes extend forward from the hub of the fan at an angle within the range of 40 degrees to 50 degrees to the axis of rotation of the fan; more preferably, the vanes of the fan extend forward at an angle of 45 degrees to the axis of rotation of the fan Preferably, each of the vanes has a slot extending substantially parallel to the axis of rotation of the fan and having a depth of 2% and a width from 1% down to 0.3% of the overall length of the vane. The slot may be located at a distance from the hub of the fan at the edge of the impeller inlet. The impeller width is reduced to only about 44% by the time it reaches the hub as its configuration is such that there is a 13.0517291 degree angle on one side of the vane (at the back of the rotor) and a 45 degree angle on the opposite leading edge side of the vane, which shortens the width of the vane.

Preferably, each vane extends radially at an angle within the range of 3.141592653 degrees to 17.15850413 degrees to the radius of the fan. Preferably, each vane is concave in profile such that the concavity faces in the direction of the rotation of the fan. Preferably but not necessarily), each vane is coated with a high abrasion-resistant material with impact resistant material on the leading edges and interrupter—all which preferably was achieved without heat treatment—in the case of heat treatment, the metal would preferably be magnetized afterwards. Preferably, the curvature of the vanes is adjusted for a particular material by computer-aided design to take account of fluid dynamics and wear rates.

The diameter of the impeller rotor suction fan will be 3 times the diameter of the of the inlet tube—tolerant to plus or minus 38.1 mm, or one and a half inches. A rotor will preferably have a diameter of 612.7753422 mm and would require a high speed motor, in the order of 200 Kw, that can turn the impeller at speeds up to 7222 rpm

The fan further comprises an interrupter located on the hub, to assist the configuration of a ‘boundary cylinder’ with a ‘boundary envelope’ immediately in front of the hub. The diameter of the interrupter must not be more than the diameter of the hub. Preferably, its diameter would be 66 and ⅔% that of the diameter of the hub.) The 3 to 7 mm (preferably 5 mm) thick vanes, lean back 5 degrees from the center of the hub—whose diameter is preferably not more than 14.618% of the diameter of the impeller suction fan—which also has a specially configured interrupter attached to it—the height of which must not protrude into the ‘N’ section or beyond the leading front edge of the vane—the vane must not protrude past the point where ‘N’ and ‘J’ meet. The interrupter has two ‘rounded peaks’. Mid-way up the higher ‘peak’ is a square-faced hole (15.1 mm deep, with a 4.6 mm diameter) drilled at an angle of 45 degrees. The smaller ‘peak’ also has a hole, 4 6 mm deep with a 1 mm diameter, drilled into it

The invention also utilizes a feed assembly conveyor system. The material to be processed is transported on the conveyor and dropped a distance of at least 0 6 of the radius of the inlet tube (about 10% of the rotor's diameter), in front of the start of the inlet tube, at which point the air stream pulls the material into the inlet tube—or, in the case of a vertical inlet tube, increasing the electrostatic field and usage [in its intensity] of static electricity in the conical section and rotor. The conveyor system would then be placed the same distance beneath the inlet tube. The space between the conveyor and the inlet is required to allow the frequencies free access in front of the tube.

The invention also comprises a computer programme containing all Fourier and Laplace equations, together with the formulae that realizes, and incorporates, Mark Youds' ‘Factors of Vortexian energy sources’, wherein the computer relays the optimum configuration of the invention, for each material, to the operator of the invention or directly to the apparatus. (If a slight fluctuation in the frequencies present is detected, then the rotor speed and tube length could be altered to rectify the situation) The discharge exit area ducting will have the same cross-sectional area as the inlet tube. Note: All of the apparatus is preferably surrounded by a sound-proof fabrication

The invention further comprises a computer feed-back system that will alter the speed of the rotor according to the formulae. The inlet tube may have a hydraulic mechanism which allows the computer to vary the length of ‘L’ according to the formulae with over 20 equations.

The invention will preferably utilize a safety cut-off mechanism with sensors to detect any increase in load beyond the capacity of the invention The computer feed back may utilize a laser(s) microphone(s), either pulsed or non-pulsed; reflectors, thermometers; air-speed, rotor speed indicators; strobe light(s): a sound level meter, barometer; humidity meter, density meter; and a frequency spectrum analyzer.

The invention further utilizes a cyclone into which material flows in the air stream after leaving the outlet area. The cyclone further enhances the process and may be used for controlling flocculation and precipitation, together with the effect of providing the necessary backpressure required for optimum configuration of the invention.

Head and ear protection should be worn, just in case the sound upsets the 12 cycles per minute cranial impulse—produced by cerebrospinal fluids (CSF), which allow for the natural movement of the 22 bones in the skull

The invention may further incorporate the Mark Youds ‘Crystalline structure enhancer’, as defined in granted patent serial no. GB2337514, to enhance the crystalline structure of the product with an additional input of frequencies generated to alter the relevant material's crystalline structure, in order to create additional properties within the material In the case of gypsum for example, 5% of the end product will be a chemical water that enhances the fireproofing equality of the gypsum. The gypsum will also have longer crystals with greater bonding ability when the gypsum is re-hydrated.

The apparatus will not adequately process material if the ambient air temperature is below −65.5 Celsius (−107.1 Fahrenheit) or above 94 and two-thirds Celsius (202.24 Fahrenheit). The preferred mean temperature range is between 25 C and 42 C

A further factor to be taken into account) by those skilled in the art, is the fact that the resonant frequencies of materials must be periodically checked for any alteration caused by the changes occurring to our planet's resonant frequency, which has increased in recent decades and is continuing to rise.

A century ago, our planet's frequency was about 7.83 Hz. This figure has probably increased to no more than 8.258203125 Hz—i.e. in line with the increase occurring generally in the Universe. This is relevant if old data at the 7.83 Hz value is being utilized by the apparatus operator. If this were the case, rather than take further readings it would be simpler, for example in the case of 8.258203125 Hz, to multiply ‘F’ and ‘K’ by 1.0546875 (because 7 83 Hz multiplied by 10546875=8.258203125 Hz) for use in the above equations. However, due to the complex nature of the processes taking place inside the machine, and in order to maintain near linearity, this could only be used to obtain the desired rotor speed. To find the desired ‘I’, the original value for ‘K’ should be used to determine ‘U’—therefore the value ‘I’ to actually be used in operation=‘T’ divided by old value ‘U’.

Although a higher ultrasonic value may be used, for theoretical purposes it is possible that the old frequency value appears to be still active in the ‘Corona’ due to the ‘red-shift’ relationship with the Earth's gravitational field. (Unusually, this ‘red-shift’ might occur between a third and fourth harmonic rather than between the first and second, without any reduction in the energy of the photons.)

The ‘general pattern’, for all frequency values input, is that a third of 1 degree Celsius (1.8 Fahrenheit) increase/decrease in temperature equates to a 6 rpm increase/decrease in the rotor's speed and a 1 mm increase/decrease in the length of the inlet tube, when the impeller speed is 0.75 that of the air speed entering the inlet tube. The user must establish the speed of sound value and input it into the equations Furthermore, the user must also take into account equations 19 and 20, regarding the rotor speed and tube length degrees of accuracy

In the equation, C is less than Q, space is ‘folded’ due to a rapid increase in captured photons sympathetically vibrating with their counterparts at an immeasurable distance—rather than as a result of virtual photons being produced by the vacuum—assisted by, but not due to, the solitons being squeezed—which also assists the refinement of the ultrasonic frequency and the creation of negative feedback.

When space ‘folds’—rather than being ‘warped’, dissociation of water reduces dramatically but implosions within matter, for comminution, increases dramatically. This is because the ‘vacuum polarization zone’ is now in front of the ‘corona’, rather than below it. The percentage of CAF taking place also increases. (‘C’ minus ‘Q’) divided by (‘C’ divided by 2‘P’) multiplied by 5.4617215=the percentage of time that the CAF process takes place. (The higher the CAF [cold fusion] time, the less water dissociated.)

(The ‘folding’ effect explains why some theories intimate that you can go faster than light or that time reversal is possible. Non-space time and space folding is transitional only and therefore degradation has only been delayed. However, the two of them combined means space actually collapses without precession.)

The range of fundamental frequency values that may be input, by using the formulae with over 20 equations, into the ‘Youds factor’ zone, in order to establish a standing wave within the material at the ‘corona’ and ‘vacuum polarization zone’, is between 27,618 and 45,696, with the sonic input range choice being between 103 and 359. The diameter of the rotor also has extreme ranges from 426 mm (18.19 inches) to 847 mm (33.35 inches) (Please note, from using the equations it can be shown that the smaller the rotor diameter, the faster it needs to go for processing.)

It should be stressed that the ranges quoted are only the extremes relative to commercial viability. Specialized applications are therefore still possible. However, the resonant acoustic wave frequency values of materials for processing, particularly sewage and bio-solids, will be well within the quoted ranges.

To estimate how much water will be removed from the sewage you can use the following guideline. (‘C’ divided by 2‘P’) minus the distance between ‘C’ and ‘Q’=a variable. Divide this variable by (‘C’ divided by 2‘P’)=another variable. Multiply this new variable by the percentage of water in the sewage to find the number of percentage points that will be deducted (‘PD’) from the original percentage of water in the sewage. However, at cooler ambient air temperatures the actual percentage of water removed may increase because of increased conductivity transmission rates when the temperature declines. The figure would also be slightly higher due to a reduced through-put of material in colder temperatures and the material would also be in the dissociation zone for longer, due to the ‘reduction’ in the air speed.

On a continuous basis, it is recommended, as a guide, that the apparatus will process 0 646943895 kg per hour of sewage, for every 1 rpm of the rotor, which could be made from Titanium. For every increase above the through-put guide figure, a proportional decrease in the amount of water dissociated will occur. For example, an 8% increase in the amount of sewage fed into the apparatus, above the ‘guide’ figure given above, would result in an 8% reduction of ‘PD’ (The interior of the inlet tube could have an aluminium lining.)

From an heuristic viewpoint this technology, when space is folded, could be utilized to promote both: the transmutation of matter; and, interstellar) interplanetary, and interdimensional travel. However, please note that oxygen must surround the apparatus in order to avoid hydrogen embrittlement (Suffusion of hydrogen gas can make metal brittle.) The technology could also be utilized in antigravity devices, as well as being used to detoxify poisons, deactivate dangerous chemicals, and produce cheaper drugs. An input of certain frequencies would enable the apparatus to generate its own vortex space energy, which could be collected and used as an energy source.

Theological Quantum Cosmology

The duality of particles/waves should be viewed from the perspective of the vibration from the nucleus, acting as a protective barrier to its programming. Particles form themselves into waves through sympathetic attraction to the protective wave barrier. Therefore, the nucleus is dictating the wavelength to the electron

From a theological cosmology all matter is attracted in an effort to achieve consciousness. This ‘ether’ type consciousness is beyond the ‘ether’ type factor of the space-wave vortex ‘Youds effect particle resource pool’ energy source. These neutral mass particles (i.e. the particles in the pool are neither matter nor anti-matter) do not revolve until an external source—even thought induced gravity—activates them in their potential fields to produce positive mass. This is where confusion arises in theories looking for the ‘ether’, which should really determine what precisely it is they are looking for.

In a magnetic field, when particular external frequencies bombard the nucleus, the radiative electron particles are further excited and change their orbital movement During self-polarization, if you sufficiently alter the vibration from the nucleus, then solid matter may cease to be solid, together with an excess combination of electrons whose up/down equilibrium has now been destroyed. (Although the out of phase waves cause interference and cancel each other out, the inward dialectic particles remain and are attracted.) This is much easier to achieve out of space-time.

The practical knowledge outlined in this patent obtained theoretically and empirically, is limited to only sufficiently altering the matrix of frequencies within the nucleus in order to control the processes also outlined herein. However, if you could accurately dictate the structure of the matrix you could therefore create any kind of matter you desire—only if the relationship between the particle spectrum (and its physical probability factor [as an imaginary number only]) and the nucleus wave (and its matrix matrices, is established (I.E. particle to wave, not wave to wave.) Greater attention should be paid to the precise speed of sound factor when analyzing quantum data. Possible since May 1997, thanks to the Technical University of Denmark's Department of Acoustic technology.)

1. A process invention using formulae, methods, and apparatus; consisting of: apparatus referred to in any of claims 4, 6, and 9 to 14; wherein the preferred embodiment, established by a formulae in any of claims 5 and 6, of that apparatus, will create those factors, outlined in the specification, required for: vortexian energy; material processing; material treatment; drying; dissociation; comminution; together with those processes and methods outlined in any one of the claims 1, 3, 7, 8, and 15 to 20.

2. The process according to claim 1, further comprises a combination of processes in the apparatus occurs without a chronology, no time lapses between either implosion and/or explosion (depending upon the material being processed), cavitation, or the extreme ranges is temperature and pressure etc (except for the vacuum created implosion that occurs at the ‘boundary layer’ of the ‘boundary cylinder’ hyper-spatial intersection between non space-time and space-time created by this invention), to be known as the ‘Youds factor’.

3. Process according to claim 1 whereby the covalent sigma bond of H2O is broken.

4. The process according to claim 1, further utilizes computer apparatus, where the computer relays the optimum configuration to the operator or to the apparatus, which further comprises laser(s) microphone's) reflectors, thermometers, air-speed and rotor speed indicators, strobe lights, sound level meters, and frequency analyzers

5. Process for configurating the apparatus', outlined in any of claims 1, 4, 6, and 9 to 14, engineered dimensions and operating parameters, comprising formulae invented to create those factors outlined in claim 1: A=constant value 9; B=variable value B; C=maximum ‘boundary cylinder’ length; D=distance from the start of the sound wave to the back of the hub; E=Speed of sound value in millimeters per second; F=ultra-sonic frequency value, in the range 27,618 to 45,696; G=distance from the back of the hub to the wider edge of the conical, H=combined length of the conical section length and the sound wave; I=inlet tube length; J=conical section length; K=the sonic frequency value, in the range 103 to 359; L=distance from the start of the inlet tube to the outside of the rotor housing casing; M=length from the start of the sound wave to the outside of the rotor housing casing; N=exterior distance from the wider edge of the conical section to the rotor housing O=optimum configuration for combined dissociation and comminution; P=constant value 8; Q=minimum length of the ‘boundary cylinder’; r=radius of the inlet tube; R=rotor tip speed; S=variable value; T=air speed; U=K divided by 0.75; V=one-third of I; W=one-third of X; X=3K; Y=constant value 5; and Z=optimum condition for harmonic frequency precision: The main equations (see FIG. 2):
1. F divided by A=B
2. E divided by B=C
3. 2(A multiplied by C)=D
4. D minus G=H
5. H minus J=I
6. I multiplied by K=R
7. H plus N=M
8. M minus 0.6 r=L
9. (H divided by 2) divided by P=Q
10. (E divided by 2H) multiplied by Y=S
11. T divided by I=U
12. R divided by X=V
13. I=T divided by U
14. W=R divided by I
15. Distance Q to C=The ‘corona’ and ‘vacuum polarization nexus zone’
16. When S=X, then Z
17. When C=Q, then O
18. Space is folded when C is less than Q
19. 3(R divided by S)+J+N−0.6 r−‘L’=degree of accuracy for ‘L’ in mm.
20. 3(R divided by S) multiplied by K, minus R, divided by the rotor's circumference multiplied by 60=the degree of accuracy in the rotor's speed.

6. A process according to any of claims 1 and 5, whereby (‘F’ divided by 6) divided by (The RPM established from ‘R’ divided by 10)=the preferred number of vanes to be used on the impeller rotor (RPM means revolutions per minute).

7. The process according to claim 1 whereby when the correct frequencies are input it can: generate vortex space energy, which could be collected and used as energy source; be applied to interstellar, inter-dimensional interplanetary travel; anti-gravity devices, time travel; fold space; and generate said frequencies.

8. A process according to claim 1 whereby chemical activity changes the hydrogen and oxygen molecules into other molecular structures, including matter transmutation.

9. A process according to any of claims 1, 5 and 6, invented to configure an apparatus to process material, further comprising a comical section with inlet tube; a rotor housing for containing a rotor; the rotor housing having an inlet and an outlet, a rotor having 8 to 12 radially extending vanes for creating vortices and reverse vortices, upstream in a cyclonic air-stream within the preferably 10.6-13) degree (depending upon the actual length of the conical section, and the diameter of the inlet tube) sloping conical section via the inlet of the rotor housing; a feed inlet tube for feeding the said material into the path of the centripetal ‘boundary cylinder’ and ‘envelope’, as described in the specification, within the conical section, and the rotor, wherein the leading edges of which must not protrude beyond the point where ‘N’ and ‘J’ meet.

10. The process according to claim 1, whereby the rotor is preferably magnetized

11. The process according to claim 1, whereby an interrupter is preferably made of a nickel alloy, which will enhance the processing of material.

12. A process according to claim 1 whereby the additional use of an apparatus, in granted Patent serial No. GB2337514, will enhance the properties of the processed product.

13. A process according to claim 1, whereby the inlet tube is lined with aluminium, enhancing the quality of the frequency when the interrupter is made of a nickel alloy.

14. A process according to claims 1 wherein the rotor inlet ring is made of brass, which will turn the kinetic energy in moisture into mechanical energy.

15. The process according to any of claims 1, whereby the following takes place: the elimination of bacteria, and the initiation of the formation of micro floc.

16. A process according to claim 1, wherein an increase in pH will reduce hydronium concentration, thereby increasing electrocatalytic ion or couple cations

17. The process according to claim 1, whereby the corona's photons exist at both their alpha state and omega state, simultaneously.

18. The process according to claim 1, whereby the combustion energy equivalent to dissociate water, achieved by the apparatus, exceeds the energy required to run the motor.

19. A process according to claim 1, whereby poisons are detoxified, and dangerous chemicals are deactivated

20. The process according to claim 1, whereby the preferred embodiment of the apparatus according to formulae will: optimize the said preferred embodiment, optimize similar designed apparatus that has hitherto not been commercially viable; and also create those factors of Vortexian energy sources also outlined in the specification.
